(19) United States
(12) Patent Application Publication
(10) Pub. No.: US 2013/0143133 A1
(43) Pub. Date: Jun. 6, 2013

(54) CATHODE CATALYST FOR RECHARGEABLE METAL-AIR BATTERY AND RECHARGEABLE METAL-AIR BATTERY

(71) Applicants: Fanny Jeanne Julie Barde, Houwaart (BE); Laurence James Hardwick, Liverpool (GB); Peter George Bruce, Newport-on-Tay (GB); Stefan Freunberger, Graz (AT)

(72) Inventors: Fanny Jeanne Julie Barde, Houwaart (BE); Laurence James Hardwick, Liverpool (GB); Peter George Bruce, Newport-on-Tay (GB); Stefan Freunberger, Graz (AT)

(73) Assignees: The University Court of the University of St. Andrews, St. Andrews, Fife (GB); TOYOTA JIDOSHA KABUSHIKI KAISHA, Toyota-shi, Aichi (JP)

(21) Appl. No.: 13/699,897

(22) PCT Filed: May 28, 2010
(86) PCT No.: PCT/JP2010/059494

§ 371 Date: Feb. 12, 2013

(51) Int. Cl. H01M 4/90; H01M 12/08

(52) U.S. Cl. CPC H01M 4/9016; H01M 12/08
USPC 429/405; 423/594.1

(57) ABSTRACT

The present invention is to provide a cathode catalyst capable of increasing the initial capacity, decreasing the charging voltage and improving the capacity retention of a rechargeable metal-air battery, and a rechargeable metal-air battery having high initial capacity, excellent charge-discharge efficiency, and excellent capacity retention. A cathode catalyst for a rechargeable metal-air battery comprising NiFe₂O₄, and a rechargeable metal-air battery comprising an air cathode containing at least NiFe₂O₄, an anode containing at least a negative-electrode active material and an electrolyte interposed between the air cathode and the anode.

### TECHNICAL FIELD

The present invention relates to a cathode catalyst for a rechargeable metal-air battery and a rechargeable metal-air battery.

### BACKGROUND ART

In recent years, with rapid widespread use of information-related devices and communication devices such as computers, video cameras and cellular phones, emphasis is placed on developing batteries used as the power source of the above devices. Also, in the automobile industry, development of batteries for electric vehicles and hybrid electric vehicles, having high output and capacity, is encouraged. Among various kinds of batteries, rechargeable lithium batteries receive attention since the energy density and output of the rechargeable lithium batteries are high.

As rechargeable lithium batteries for electric vehicles and hybrid electric vehicles, which require high energy density, lithium air batteries particularly receive attention. The lithium air batteries use oxygen in air as a positive-electrode active material. Thus, the capacity of the lithium air battery can be larger than that of a conventional rechargeable lithium battery using transition metal oxide such as lithium cobalt oxide as a positive-electrode active material.

The reaction of the lithium air battery varies by the electrolyte solution being used. However, the following reaction of the lithium air battery when lithium metal is used as a negative-electrode active material is known.

### (Discharging)

Anode: Li→Li⁺+e⁻

Air cathode: 2Li⁺+O₂+2e⁻→Li₂O₂

or

4Li⁺+O₂+4e⁻→2Li₂O

### (Charging)

Anode: Li⁺+e⁻→Li

Air cathode: Li₂O₂→2Li⁺+O₂+2e⁻

or

2Li₂O→4Li⁺+O₂+4e⁻

A lithium ion (Li⁺) in the reaction at the air cathode at the time of discharge is a lithium ion (Li⁺) having dissolved from the anode by electrochemical oxidation and having moved from the anode to the air cathode via an electrolyte. Oxygen (O₂) is oxygen supplied to the air cathode.

Since the reaction rate of the electrochemical reaction of oxygen at the air cathode is slow, the overpotential of the air cathode is large, so that the voltage of battery easily decreases. Thus, to increase the reaction rate of the electrochemical reaction of oxygen, addition of an oxygen reaction catalyst to the air cathode has been attempted (for example, Patent Literatures 1 to 4 and Non Patent Literatures 1 to 9). For example, Patent Literature 1 and Non Patent Literature 4 disclose an air battery using MnO₂ as an oxygen reaction catalyst at an air cathode. In Non Patent Literature 3, the effect of a catalyst such as Fe₂O₃, Fe₃O₄, CuO and CoFe₂O₄ at the cathode of a rechargeable lithium-air battery has been studied.

On the other hand, Non Patent Literature 10 discloses a NiFe₂O₄ nanoparticle as the anodic material of a lithium ion battery.

Patent Literature 1: Japanese Patent Application Laid-open (JP-A) No. 2009-170400

Patent Literature 2: U.S. Pat. No. 7,147,967 B1

Patent Literature 3: U.S. Pat. No. 7,807,341 B1

Patent Literature 4: WO 02/13292 A2

Non Patent Literature 1: Rechargeable Li₂O₂ Electrode for Lithium Batteries, T. Ogasawara, A. Debart, M. Holzapfel and P. G. Bruce, J Am Chem. Soc., 128, 1390-1393 (2006).

Non Patent Literature 2: Effect of catalyst on the performance of rechargeable lithium/air batteries, A. Debart, J. Bao, G. Armstrong, P. G. Bruce. ECS Transactions, 3225-2328 (2007).

Non Patent Literature 3: An O₂ Cathode for Rechargeable Lithium Batteries, the effect of catalyst, A. Debart, J. Bao, G. Armstrong, and P. G. Bruce. J Power sources, 174. 1177-1182 (2007).

Non Patent Literature 4: a-MnO₂ nanowires: a catalyst for the O₂ electrode in rechargeable Li-battery, A. Debart, A. J. Paterson, J. Bao, P. G. Bruce. Angewandte Chemie, 2008, 47, 4521-4524.

Non Patent Literature 5: Lithium-air batteries using hydrophobic room temperature ionic liquid electrolyte, Kukobi. 2005, Jornal of Power sources, Toshiba.

Non Patent Literature 6: Fall 2004 meeting of ECS.

Non Patent Literature 7: A. Dobley, R. Rodriguez, and K. M. Abraham, Yardney Technical Products Inc./ Lition, Inc., 2004 Joint International Meeting, 2004 Oct. 3-8, C-1 Battery & Energy Technology Joint General Session.

Non Patent Literature 8: A. Dobley, J. Di Carlo, and K. M. Abraham, Yardney Technical Products Inc./ Lition.

Non Patent Literature 9: J. Read, Journal of Electrochem. Soc. 149, (9), A1190-A1195, (2002).

Non Patent Literature 10: H. Zhao, Z. Zheng, K. W. Wong, A. Wang, B. Huang, D. Li, Electrochem. Commu., 9, 2606 (2007).

### SUMMARY OF INVENTION

### Technical Problem

However, even if the conventional cathode catalysts for rechargeable metal-air batteries disclosed in the above Patent Literatures 1 to 4 and Non Patent Literatures 1 to 9 are used, there are problems in such batteries that: (1) the initial capacity is low; (2) the difference between discharging voltage and charging voltage is large, so that the charge-discharge efficiency is low; and (3) the capacity retention is low, so that the cyclability is inferior.

The present invention has been made in view of the above circumstances, and it is an object of the present invention to provide a cathode catalyst capable of increasing the initial capacity, decreasing the charging voltage and improving the capacity retention of a rechargeable metal-air battery, and a rechargeable metal-air battery having high initial capacity, excellent charge-discharge efficiency, and excellent capacity retention.

### Solution to Problem

A cathode catalyst for a rechargeable metal-air battery of the present invention comprises NiFe₂O₄.

According to the cathode catalyst for a rechargeable metal-air battery (hereinafter, it may be simply referred to as a cathode catalyst) of the present invention, the initial capacity of a rechargeable metal-air battery can be increased at the same time as reducing the charging voltage of the rechargeable metal-air battery and keeping excellent capacity retention of the rechargeable metal-air battery.

A rechargeable metal-air battery of the present invention comprises an air cathode containing at least NiFe₂O₄, an anode containing at least a negative-electrode active material and an electrolyte interposed between the air cathode and the anode.

According to the present invention, a rechargeable metal-air battery having excellent electrochemical performance such as the above-mentioned initial capacity, charging voltage and capacity retention can be obtained.

### Advantageous Effects of Invention

According to the present invention, the initial capacity of a rechargeable metal-air battery can be increased, the charging voltage of the rechargeable metal-air battery can be reduced and the capacity retention of the rechargeable metal-air battery can be improved.

### BRIEF DESCRIPTION OF DRAWINGS

FIG. 1 is a schematic view describing a structure of a rechargeable metal-air battery.

FIG. 2 is a view showing a result of XRD of NiFe₂O₄ in Example 1.

FIG. 3 is a TEM image of NiFe₂O₄ in Example 1.

FIG. 4 is a view showing a relationship (4a) between capacity and voltage, and a relationship (4b) between cycle number and capacity of a rechargeable metal-air battery in Example 1.

FIG. 5 is a view showing the capacity retention of rechargeable metal-air batteries in Examples and Comparative examples.

### DESCRIPTION OF EMBODIMENTS

A cathode catalyst for a rechargeable metal-air battery of the present invention comprises NiFe₂O₄.

As a result of diligent researches, the inventors of the present invention found out that the above object can be attained by using NiFe₂O₄ being binary oxide as a catalyst for cathode (air cathode), i.e. an oxygen reaction catalyst, in a rechargeable metal-air battery. By using NiFe₂O₄ as a catalyst of an oxygen reaction, a rechargeable metal-air battery can achieve increase in initial capacity, decrease in charging voltage, and improvement in capacity retention. This reason is mainly assumed that NiFe₂O₄ facilitates the oxidation of O₂⁻ or O₂²⁻ during the charge, that is, NiFe₂O₄ facilitates the decomposition of Li₂O₂ and the production of O₂.

Therefore, by using the cathode catalyst of the present invention, a rechargeable metal-air battery having high initial capacity, excellent charge efficiency, and excellent cyclability can be obtained.

Hereinafter, the cathode catalyst and the rechargeable metal-air battery of the present invention will be described in detail.

The particle diameter of the cathode catalyst is not particularly limited. From the viewpoint of efficient decomposition of lithium oxide in a solid state, generally, the primary particle diameter of the cathode catalyst is preferably 1 nm or more, more preferably 5 nm or more. On the other hand, from the viewpoint of efficient decomposition of lithium oxide in a solid state, the primary particle diameter of the cathode catalyst is preferably 50 nm or less, more preferably 20 nm or less. The particle diameter of the cathode catalyst can be, for example, calculated from Full Width at Half Maximum (FWHM) in radians obtained by the XRD measurement using Scherrer's formula, or an actual measurement using a TEM image.

The surface area of the cathode catalyst is not particularly limited. From the viewpoint of efficient dispersion of the cathode catalyst, generally, the surface area of the cathode catalyst is preferably 1 m²/g or more, more preferably 10 m²/g or more. On the other hand, from the viewpoint of efficient dispersion of the cathode catalyst, the surface area of the cathode catalyst is preferably 400 m²/g or less, more preferably 200 m²/g or less. The surface area of the cathode catalyst can be obtained, for example, by the BET method or the like.

A method for producing the cathode catalyst is not particularly limited. For example, any of known methods including the solid-phase reaction method and the liquid-phase reaction method such as the organic acid method and the coprecipitation method can be employed. In the solid-phase reaction method, for example, mixed powder, in which a nickel compound and an iron compound are mixed so that the molar ratio of nickel to iron is 1:2, is baked at high temperature of 1,000° C. to 1,300° C. and pulverized, and thus, NiFe₂O₄ powder can be obtained. In the organic acid method, for example, organic acid such as citric acid or oxalic acid is added to an aqueous solution containing a nickel salt and an iron salt, they are mixed and reacted in a liquid phase to prepare a complex salt of the organic acid, the complex salt is thermally decomposed, and thus, NiFe₂O₄ powder can be obtained. In the coprecipitation method, for example, pH of a solution containing a nickel salt and an iron salt is adjusted to coprecipitate the nickel salt and iron salt, thus obtained coprecipitation product is heated and oxidized, and thus, NiFe₂O₄ powder can be obtained.

As more specific method for producing the cathode catalyst, a method disclosed in Non Patent Literature 10 can be exemplified. The method disclosed in Non Patent Literature 10 is the coprecipitation method.

Specifically, a Ni compound and a Fe compound are firstly mixed so that the molar ratio of Ni to Fe is 1:2, and dissolved in water to mix. Herein, the Ni compound and the Fe compound are not particularly limited, and may be oxide, chloride, nitrate, etc. Specific examples of the Ni compound include Ni(NO₃)₂, and nickel chloride (NiCl₂.6H₂O). Examples ofthe Fe compound include Fe(No₃)₃, and FeCl₃. As a solvent to dissolve the Ni compound and the Fe compound, citric acid (C₆H₈O₇.H₂O), ethylene glycol, or NaOH solution can be used besides water.

After the Ni compound and the Fe compound are sufficiently dissolved in water, a precipitant is added in thus obtained mixture to adjust pH of the mixture to pH 8, for example. Thus, a precipitate is produced. Examples of the precipitant include ammonia and ammonium carbonate.

Next, the obtained solution is heated to oxidize the precipitate to obtain a cathode catalyst (NiFe₂O₄). The heating temperature is preferably, for example, in the range from 230° C. to 700° C. The precipitate may be oxidized by heating the solution itself, or by heating the precipitate separated by filtration.

It is preferable that the obtained cathode catalyst is accordingly washed, if necessary.

The rechargeable metal-air battery of the present invention comprises an air cathode containing at least the cathode catalyst (NiFe₂O₄) of the present invention described above, an anode containing at least a negative-electrode active material and an electrolyte interposed between the air cathode and the anode.

As described above, the air cathode of the rechargeable metal-air battery of the present invention contains the cathode catalyst of the present invention, in which the rechargeable metal-air battery can attain improvement in initial capacity, decrease in charging voltage, and improvement in capacity retention. Therefore, the rechargeable metal-air battery of the present invention is excellent in initial capacity, charge efficiency and cyclability.

Hereinafter, an example of the constitution of the rechargeable metal-air battery of the present invention will be explained. However, the rechargeable metal-air battery of the present invention is not limited to the following constitution.

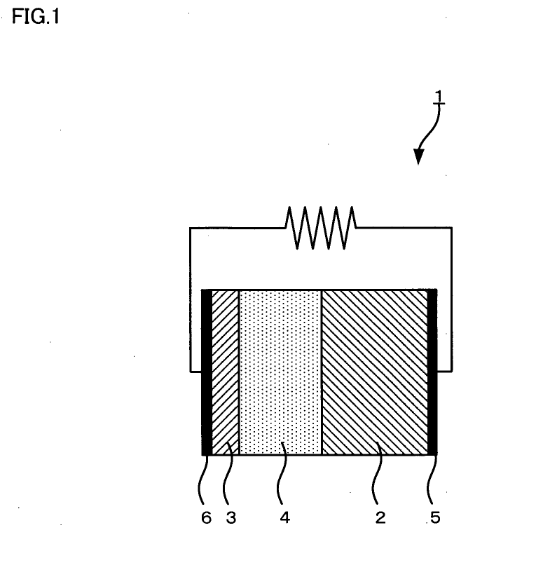

FIG. 1 is a sectional view showing an embodiment of the rechargeable metal-air battery of the present invention. The rechargeable metal-air battery 1 is constituted with an air cathode 2 using oxygen as an active material, an anode 3 containing a negative-electrode active material, an electrolyte 4 conducting ions between the air cathode 2 and the anode 3, an air cathode current collector 5 collecting current of the air cathode 2, and an anode current collector 6 collecting current of the anode 3, and housed in a battery case (not shown).

The air cathode 2 is electrically connected to the air cathode current collector 5 collecting current of the air cathode 2. The air cathode current collector 5 has a porous structure which can supply oxygen to the air cathode 2. The anode 3 is electrically connected to the anode current collector 6 collecting current of the anode 3. One end of the air cathode current collector 5 projects from the battery case and functions as a cathode terminal (not shown). One end of the anode current collector 6 projects from the battery case and functions as an anode terminal (not shown).

### 1. Air Cathode

The air cathode generally has a porous structure and contains a conductive material, besides NiFe₂O₄ being an oxygen reaction catalyst. The air cathode may also contain a binder etc., if necessary.

The explanation for NiFe₂O₄ is omitted here since NiFe₂O₄ is explained above. The content of NiFe₂O₄ in the air cathode is not particularly limited. From the viewpoint of improving oxygen reaction performances of the air cathode, for example, the content of NiFe₂O₄ is preferably from 1 to 90 wt %, more preferably from 10 to 60 wt %, even more preferably 45 wt %.

The conductive material is not particularly limited as long as it is one which is generally usable as a conductive additive. As a suitable conductive material, conductive carbon can be exemplified. Specific examples of the conductive carbon include mesoporous carbon, graphite, acetylene black, carbon nanotube and carbon fiber. The conductive carbon having a large surface area is preferable since it can provide more reaction fields in the air cathode. Specifically, the surface area of conductive carbon is preferably from 1 to 3,000 m²/g, more preferably from 500 to 1,500 m²/g. NiFe₂O₄ being a catalyst of the air cathode may be supported by the conductive material.

The content of the conductive material in the air cathode is not particularly limited. From the viewpoint of increase in discharged capacity, for example, the content of the conductive material is preferably from 10 to 99 wt %, more preferably from 20 to 80 wt %, even more preferably 22 wt %.

By adding a binder in the air cathode, NiFe₂O₄ and the conductive material can be fixed and the cyclability of the battery can be improved. The binder is not particularly limited. Examples of the binder include polyvinylidene fluoride (PVDF) and copolymers thereof, polytetrafluoroethylene (PTFE) and copolymers thereof, and a styrene-butadiene rubber (SBR).

The content of the binder in the air cathode is not particularly limited. From the viewpoint of the ability of the binder to bind carbon (conductive material) and the catalyst, for example, the content of the binder is preferably from 1 to 40 wt %, more preferably from 5 to 35 wt %, even more preferably 33 wt %.

The air cathode can be formed, for example, by applying a slurry prepared by dispersing the above-mentioned constitutional materials of the air cathode in a suitable solvent on a substrate and drying the slurry. The solvent is not particularly limited, and the examples include acetone, N,N-dimethylformamide and N-methyl-2-pyrolidone (NMP). Generally, it takes preferably 3 hours or more, more preferably 4 hours or more, to mix the constitutional materials of the air cathode and the solvent. The mixing method is not particularly limited, and a general method can be employed.

The substrate to apply the slurry is not particularly limited, and the examples include a glass plate, a Teflon (registered trademark) plate and the like. After the slurry is dried, the substrate is peeled from thus obtained air cathode. Alternatively, a current collector of the air cathode or a solid electrolyte layer can be used as the substrate, wherein the substrate is not peeled and used as a constitutional component of the rechargeable metal-air battery.

The methods for applying and drying the slurry are not particularly limited, and a general method can be employed. For example, any of the coating methods such as the spraying method, the doctor blade method and the gravure printing method, and any of the drying methods such as drying by heating and drying under reduced pressure can be employed.

The thickness of the air cathode is not particularly limited, and may be accordingly set depending on use of the rechargeable metal-air battery. Generally, the thickness is preferably from 5 to 100 μm, more preferably from 10 to 50 μm, even more preferably 30 μm.

The air cathode is generally connected to the air cathode current collector collecting current of the air cathode. The material and form of the air cathode current collector are not particularly limited. Examples of the material of the air cathode current collector include stainless, aluminum, iron, nickel, titanium and carbon. Also, examples of the form of the air cathode current collector include foil, plate, mesh (grid) and fiber. In particular, porous forms such as mesh are preferable since a current collector having a porous form is excellent in efficiency of oxygen supply to the air cathode.

### 2. Anode

The anode contains at least a negative-electrode active material. The negative-electrode active material is not particularly limited, and a negative-electrode active material of a general air battery can be used. The negative-electrode active material can generally absorb and release metal ions. Specific examples of the negative-electrode active material include metal such as Li, Na, K, Mg, Ca, Zn, Al and Fe, alloy thereof, oxide thereof, nitride thereof, and carbon materials.

In particular, a negative-electrode active material for a rechargeable lithium-air battery which can absorb and release lithium ions is preferable since the rechargeable lithium-air battery is excellent in energy density and output. Examples of the negative-electrode active material for the rechargeable lithium-air battery include lithium metal; lithium alloy such as lithium-aluminum alloy, lithium-tin alloy, lithium-lead alloy and lithium-silicon alloy; metal oxide such as tin oxide, silicon oxide, lithium titanium oxide, niobium oxide and tungsten oxide; metal sulfide such as tin sulfide and titanium sulfide; metal nitride such as lithium cobalt nitride, lithium iron nitride and lithium manganese nitride; and carbon material such as graphite. Among the above, lithium metal is preferable.

In the case that metal or alloy in the form of a foil or plate is used as the negative-electrode active material, the negative-electrode active material in the form of a foil or plate itself can be used as the anode.

The anode may contain at least the negative-electrode active material, and if necessary, a binder to fix the negative-electrode active material may be contained. Explanation of types and used amount of the binder is omitted here since they are the same as ones in the above-mentioned air cathode.

The anode is generally connected to the anode current collector collecting current of the anode. The material and form of the anode current collector are not particularly limited. Examples of the material of the anode current collector include stainless, copper and nickel. Examples of the form of the anode current collector include foil, plate and mesh (grid).

### 3. Electrolyte

The electrolyte is interposed between the air cathode and the anode. Metal ions are conducted between the anode and the air cathode by the electrolyte. The embodiment of the electrolyte is not particularly limited, and the examples include a liquid electrolyte, a gel electrolyte and a solid electrolyte. Herein, a lithium ion-conducting electrolyte used for a rechargeable lithium-air battery will be explained as an example.

The liquid electrolyte having lithium ion conductivity is generally a nonaqueous electrolyte solution containing a lithium salt and a nonaqueous solvent.

Examples of the lithium salt include inorganic lithium salts such as LiPF₆, LiBF₄, LiClO₄ and LiAsF₆; and organic lithium salts such as LiCF₃SO₃, LiN(CF₃SO₂)₂, LiN(C₂F₅SO₂)₂ and LiC(CF₃SO₂)₃.

Examples of the nonaqueous solvent include ethylene carbonate (EC), propylene carbonate (PC), dimethyl carbonate (DMC), diethyl carbonate (DEC), ethyl methyl carbonate (EMC), butylene carbonate, γ-butyrolactone, sulfolane, acetonitrile, 1,2-dimethoxymethane, 1,3-dimethoxypropane, diethyl ether, tetrahydrofuran, 2-methyl tetrahydrofuran and the mixtures thereof. As the nonaqueous solvent, an ionic liquid can also be used.

The concentration of the lithium salt in the nonaqueous electrolyte solution is not particularly limited, and is preferably in the range from 0.1 mol/L to 3 mol/L, more preferably 1 mol/L. In the present invention, for example, a low-volatility liquid such as an ionic liquid may be used as the nonaqueous electrolyte solution.

The gel electrolyte having lithium ion conductivity can be obtained, for example, by adding a polymer to the nonaqueous electrolyte solution to gelate. Specifically, the nonaqueous electrolyte solution can be gelated by adding a polymer such as polyethylene oxide (PEO), polyvinylidene fluoride (PVDF, product name: Kynar; manufactured by Arkema, for example), polyacrylonitrile (PAN) or polymethylmethacrylate (PMMA) to the nonaqueous electrolyte solution.

The solid electrolyte having lithium ion conductivity is not particularly limited, and a general solid electrolyte usable for a lithium-metal air battery can be used. Examples of the solid electrolyte include oxide solid electrolytes such as Li_{1.5}Al_{0.5}Ge_{1.5}(PO₄)₃; and sulfide solid electrolytes such as Li₂S—P₂S₅ compounds, Li₂S—SiS₂ compounds and Li₂S—GeS₂ compounds.

The thickness of the electrolyte varies widely by the constitution of batteries, and is preferably in the range from 10 μm to 5,000 μm.

### 4. Other Constitutions

In the rechargeable metal-air battery of the present invention, a separator is preferably interposed between the air cathode and the anode to surely obtain electrical insulation between the electrodes. The separator is not particularly limited as long as the separator has the structure capable of interposing the electrolyte between the air cathode and the anode, besides being capable of ensuring the electrical insulation between the air cathode and the anode.

As the separator, for example, a porous membrane made of polyethylene, polypropylene, cellulose, polyvinylidene fluoride or glass ceramics, or nonwoven fabric made of a resin or glass fiber can be used. Among the above, the glass ceramic separator is preferable.

As the battery case which houses the rechargeable metal-air battery, a general battery case of the rechargeable metal-air battery can be used. The form of the battery case is not particularly limited as long as it can house the above-mentioned air cathode, anode and electrolyte. Specific examples of the form of the battery case include a coin type, plate type, cylinder type, and laminate type.

The rechargeable metal-air battery of the present invention can discharge electricity by supply of oxygen being the active material to the air cathode. As the source of oxygen, oxygen gas or the like can be exemplified other than air, and preferable one is oxygen gas. The pressure of air or oxygen gas being supplied is not particularly limited and may be set accordingly.

### EXAMPLES

### Example 1

### (Synthesis of NiFe₂O₄)

In accordance with the method disclosed in Non Patent Literature 10, NiFe₂O₄ was synthesized as follows.

Firstly, Ni(NO₃)₂.6H₂O and Fe(NO₃)₃.9H₂O were dissolved in deionized water to prepare a mixture. In the mixture, the molar ratio of Ni(NO₃)₂.6H₂O to Fe (NO₃)₃.9H₂O was 1:2.

The mixture was mixed for 2 hours, and then an ammonia solution was added therein while mixing to adjust pH of the mixture to 8.

Next, thus obtained solution was poured into a Teflon-coated stainless-steel autoclave and heated up to 230° C. at a heating rate of 5° C./min., and the temperature of the solution was kept for 30 minutes.

Then, the autoclave was air-cooled to room temperature, and thus obtained precipitate was washed by distilled water for several times followed by drying the precipitate at 80° C.

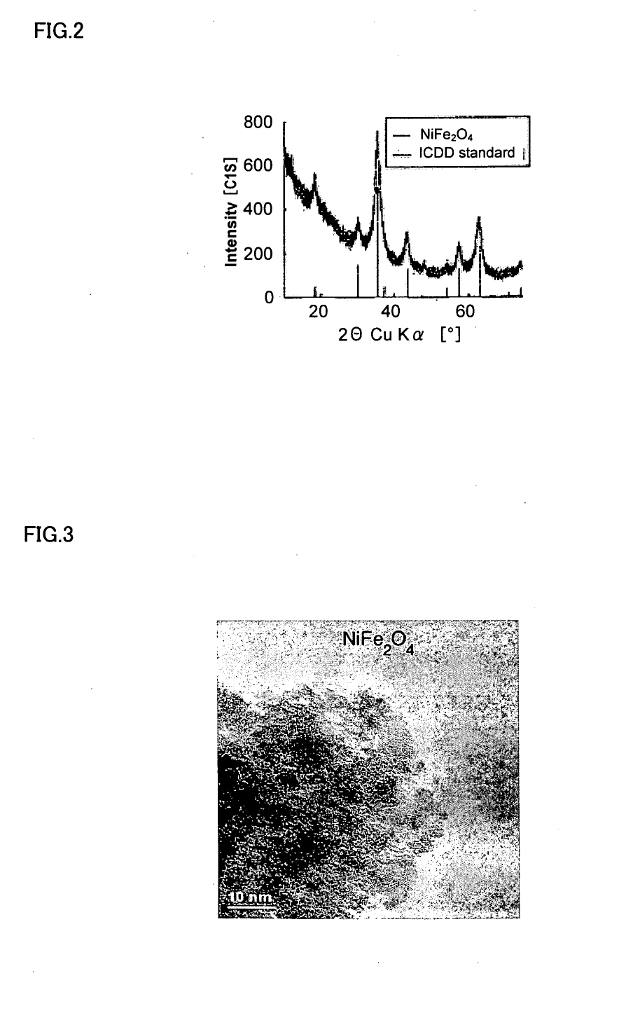

The obtained precipitate was analyzed by X-ray diffraction (XRD). The resulting X-Ray Diffractogram is shown in FIG. 2. In FIG. 2, a standard X-ray diffractogram of NiFe₂O₄ of ICDD (International Centre for Diffraction Date) is also shown.

From FIG. 2, the precipitate obtained by the above synthesis was confirmed to be NiFe₂O₄. In addition, the average crystal size of the obtained NiFe₂O₄ was 14 nm calculated from Full Width at Half Maximum (FWHM) in radians at the diffraction peak in FIG. 2 using Scherrer's formula.

The obtained NiFe₂O₄ was observed by means of TEM (transmission electron microscopy). The TEM image is shown in FIG. 3. It can be confirmed in FIG. 3 that the obtained NiFe₂O₄ was nanopowder having a particle diameter of 5 to 10 nm, which is about the same as the value calculated by the above XRD.

The surface area of the obtained NiFe₂O₄ was measured by the BET method and was 183 m²/g.

### (Assembly of Rechargeable Metal-Air Battery)

The obtained NiFe₂O₄, carbon (product name: Super P; manufactured by MMM carbon), and a binder (product name: Kynar; manufactured by Arkema; a copolymer based on PVDF) were mixed at a ratio of 45 wt %:22 wt %:33 wt % (NiFe₂O₄:carbon:binder) to prepare a slurry using an appropriate amount of acetone. Specifically, acetone was added in a container containing NiFe₂O₄, carbon and the binder, and mixed for 4 hours by means of a magnetic stirrer.

After the slurry was casted on a glass substrate, acetone was evaporated. Thus, a self-standing air cathode film having a thickness of 30 μm was formed.

Next, a rechargeable metal-air battery was assembled in a glove box under an inert atmosphere (argon) using the obtained air cathode film. Specifically, an air cathode prepared by cutting the air cathode film in the form of a disc was laid on an aluminum grid (cathode current collector) to contact each other. Separately, an anode prepared by cutting a Li foil in the form of a disc was laid on a stainless current collector to contact each other. Next, a glass ceramic separator (manufactured by Whatman) was interposed between the air cathode and the anode. Thereby, insulation between the air cathode and the anode was ensured. The glass ceramic separator of the obtained laminate was impregnated with a nonaqueous electrolyte solution (propylene carbonate solution of LiPF₆; the concentration of LiPF₆ is 1M). Thus obtained rechargeable lithium-air battery was housed in a container. Then, the container was sealed except the aluminum grid being the cathode current collector to expose the aluminum grid for oxygen supply to the air cathode.

### (Evaluation of Rechargeable Metal-Air Battery)

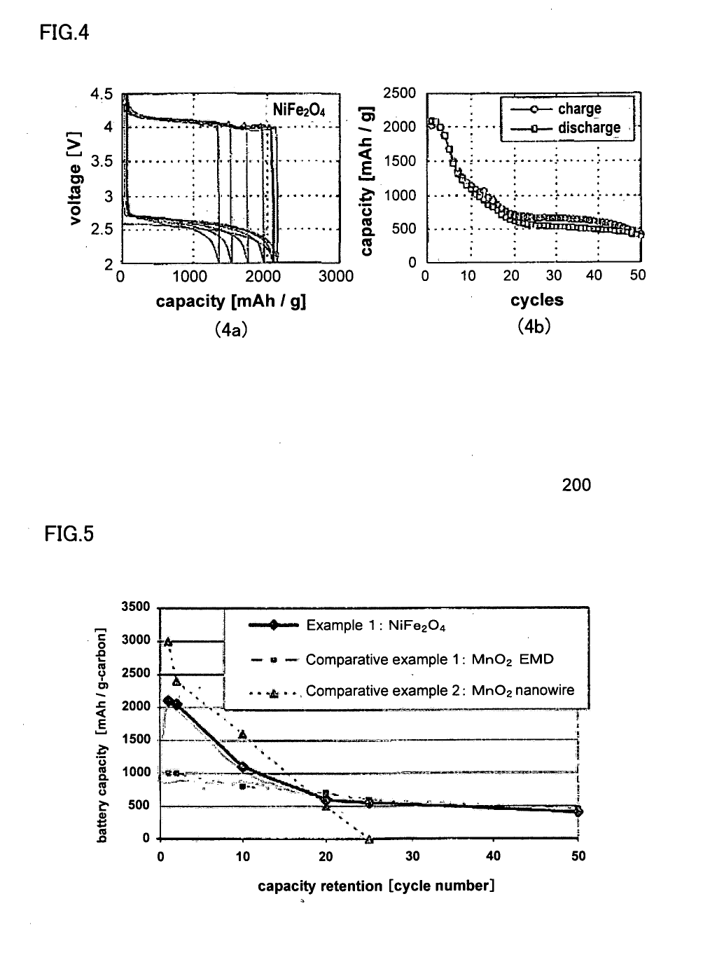

Thus assembled rechargeable lithium-air battery was removed from the glove box and put under pure O₂ at 1 atm, and a constant flow amount of O₂ was supplied to the air cathode for 30 minutes. Next, the rechargeable lithium-air battery was locked under O₂ at 1 atm, and charge and discharge (charge and discharge rate: 70 mA/g; cut-off voltage: 2.0 to 4.2 V) of the rechargeable lithium-air battery were repeated. The electrochemical performance ofthe rechargeable lithium-air battery is shown in FIG. 4.

Curves showing a relationship between capacity and voltage (vs. Li electrode) are shown in FIG. 4 (4a). A relationship (capacity retention) between charge-discharge cycle number, and charge and discharge capacity is shown in FIG. 4 (4b). The relationship (capacity retention) between the charge-discharge cycle number and the discharge capacity in FIG. 4 (4b) is also shown in FIG. 5.

### Comparative Example 1

### (Assembly of Rechargeable Metal-Air Battery)

A rechargeable lithium-air battery was assembled similarly as in Example 1 except that an air cathode was produced as follows.

A mixture containing carbon (product name: Super P; manufactured by MMM carbon), electrolytic manganese dioxide (EMD) and a binder (product name: Kynar2801; manufactured by Arkema; a copolymer based on PVDF) at the molar ratio of 95:2.5:2.5 was casted on an aluminum grid, thus the air cathode was produced.

### (Evaluation of Rechargeable Metal-Air Battery)

Similarly as in Example 1, charge and discharge (charge and discharge rate: 70 mA/g; cut-off voltage: 2.0 to 4.3 V) of the rechargeable lithium-air battery were repeated under O₂ at 1 atm. A relationship (capacity retention) between charge-discharge cycle number and discharge capacity is shown in FIG. 5.

### Comparative Example 2

### (Assembly of Rechargeable Metal-Air Battery)

A rechargeable lithium-air battery was assembled similarly as in Comparative example 1 except that a-MnO₂ nanowire was used instead of EMD.

### (Evaluation of Rechargeable Metal-Air Battery)

Similarly as in Example 1, charge and discharge (charge and discharge rate: 70 mA/g; cut-off voltage: 2.0 to 4.15 V) of the rechargeable lithium-air battery were repeated under O₂ at 1 atm. A relationship (capacity retention) between charge-discharge cycle number and discharge capacity is shown in FIG. 5.

### [Evaluation Result]

As shown in FIG. 5, in Comparative example 1 using EMD as the cathode (air cathode) catalyst, the initial capacity was about 1,000 mAh/g-carbon (hereinafter, it may be referred to as mAh/g-C), and the capacity after 50 cycles was 500 mAh/g-C.

As shown in FIG. 5, in Comparative example 2 using MnO₂ nanowire as the cathode (air cathode) catalyst, the initial capacity was 3,000 mAh/g-C and was excellent, but the capacity was not exhibited after 25 cycles.

To the contrary, as shown in FIG. 5, in Example 1 using NiFe₂O₄ as the cathode (air cathode) catalyst, the initial capacity was 2,000 mAh/g-C, which was about twice as large as that of Comparative example 1, and the capacity which was equal to that of Comparative example 1 was kept after 50 cycles. That is, by using the cathode catalyst of the present invention, the initial capacity can be increased while keeping the capacity retention of the rechargeable metal-air battery.

In addition, as shown in FIG. 4 (4a), the charging voltage of the rechargeable lithium-air battery in Example 1 was around 4 to 4.2 V, and was equal to or lower than that of the conventional art. That is, according to the present invention, the difference between the discharging voltage and the charging voltage can be small while keeping the capacity, and thus the charge-discharge efficiency can be increased.

### REFERENCE SIGNS LIST

1. Rechargeable metal-air battery

2. Anode

3. Air cathode

4. Electrolyte

5. Air cathode current collector

6. Anode current collector

1. A cathode catalyst for a rechargeable metal-air battery comprising NiFe₂O₄.

2. A rechargeable metal-air battery comprising an air cathode containing at least NiFe₂O₄, an anode containing at least a negative-electrode active material and an electrolyte interposed between the air cathode and the anode.
